(19) United States
(12) Patent Application Publication
(10) Pub. No.: US 2007/0015410 A1
(43) Pub. Date: Jan. 18, 2007

(54) Telecommunications connector with modular element

(76) Inventors: John A. Siemon, Woodbury, CT (US); Denny Lo, Bethlehem, CT (US)

Correspondence Address: CANTOR COLBURN, LLP, 55 GRIFFIN ROAD SOUTH, BLOOMFIELD, CT, 06002, US

(21) Appl. No.: 11/485,210

(22) Filed: Jul. 12, 2006

Related U.S. Application Data
(60) Provisional application No. 60/698,439, filed on Jul. 12, 2005.

(51) Int. Cl. H01R 13/66

(52) U.S. Cl. 439/620.21

(57) ABSTRACT

A telecommunications connector includes a housing and a plurality of contacts mounted in the housing, the contacts having a first connection end and a second connection end. A modular element having a plurality of leads in electrical contact with the plurality of contacts is removably mounted to the housing.

### CROSS-REFERENCE TO RELATED APPLICATIONS

This application claims the benefit of U.S. provisional patent application Ser. No. 60/698,439, filed Jul. 12, 2005, the entire contents of which are incorporated herein by reference.

### BACKGROUND

The invention relates to telecommunications connectors and in particular relates to a telecommunications connector having a modular element that can implement a number of functions. Telecommunications connectors are used in a variety of applications to provide a connection point between devices. The connectors may be plugs, outlets, connecting blocks, patch panels, etc. and carry signals for numerous applications such as voice, data, video.

Prior art outlets are compromises between optimal electrical and optimal mechanical objectives. On the one hand, an outlet optimized for electrical function such as high-frequency transmission may have these drawbacks: multiple connections between components within outlet (e.g. cable termination block, PCB, plug receptacle) create multiple defect opportunities; plated through-holes on PCBs create unwanted electrical signal interferences that add to the amount of required electrical compensation; multiple components require higher production costs and create more defect opportunities; a PCB that is a load bearing structural member of the outlet assembly is limited in its degree of achievable electrical functionality—this pushes an undesired burden of electrical tuning to the plug receptacle and cable termination block, and compromises their mechanical integrity for function and producibility.

Common methods of electrically tuning an RJ45 outlet for adequate high frequency data transmission include the use of relatively complex patterns on printed circuit boards or in the shapes of the electrical contacts. Such compensation methods depend on the precise control of PCB trace width and locations, or on the shapes and locations of metal contacts, or a combination of the two. Both of these methods require a high degree of precision and capability control in their manufacturing processes. They incur significant development and potential scrap costs. These methods are also limited by the degree of electrical tuning that is practically achievable, and by the precision required to control the physical geometries to achieve the desired electrical and mechanical properties.

On the other hand, an outlet optimized for mechanical function and producibility has these drawbacks: the electrical functionality must be designed into the mechanical structure, thus limiting the degree of electrical design freedom and electrical performance; improvements to electrical performance are difficult to implement because it is locked into the tooling design of the mechanical elements. It is also difficult to control with adequate precision and consistency using manufacturing methods other than printed circuitry.

Thus, there is a need in the art for a telecommunications connector having electrical characteristics that are separable from the mechanical, structural components.

### SUMMARY

An embodiment of the invention is a telecommunications connector includes a housing and a plurality of contacts mounted in the housing, the contacts having a first connection end and a second connection end. A modular element having a plurality of leads in electrical contact with the plurality of contacts is removably mounted to the housing.

### BRIEF DESCRIPTION OF THE DRAWINGS

FIG. 1 depicts an outlet in exemplary embodiments of the invention.

FIG. 2 depicts contacts and a modular element in exemplary embodiments of the invention.

FIG. 3 depicts contacts and a modular element in exemplary embodiments of the invention.

FIG. 4 depicts contacts and a modular element in exemplary embodiments of the invention.

FIG. 5 depicts a modular element mounted to a printed circuit board in exemplary embodiments of the invention.

FIG. 6 depicts a modular element mounted to a printed circuit board in exemplary embodiments of the invention.

### DETAILED DESCRIPTION

Embodiments of the invention provide a telecommunications connector having adjustable characteristics achieved through a modular element that provides functionality to the connector and may be altered and/or replaced with a different modular element to adjust characteristics of the connector. The modular element provides little or no mechanical, structural support for the connector.

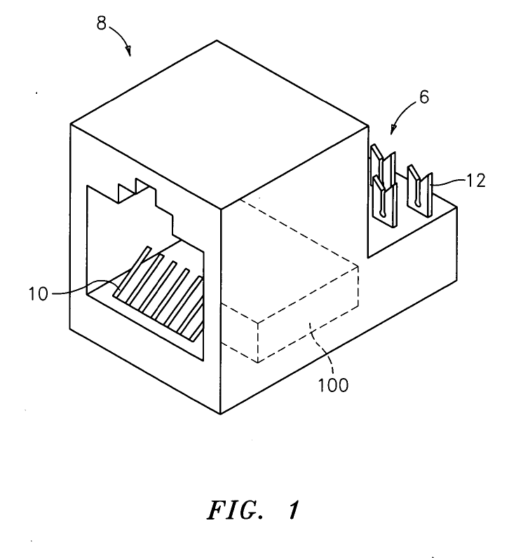

FIG. 1 depicts an RJ-45 telecommunications outlet 8 in exemplary embodiments of the invention. The outlet 8 includes a number of contacts 6 having a first connection end 10 and a second connection end 12. In the embodiment shown in FIG. 1, the first connection end 10 mates with contacts in a plug and the second connection end 12 is an insulation displacement contact that receives a wire. It is understand that FIG. 1 is an exemplary embodiment and embodiments of the invention are not limited to RJ-45 type outlets. A modular element 100 is positioned within the housing to the outlet 8.

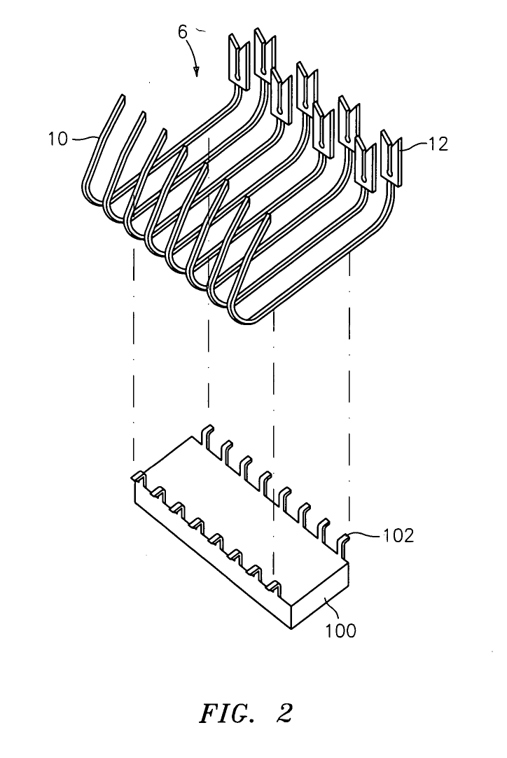

FIG. 2 depicts contacts 6 and the modular element 100. Modular element 100 is placed electrically in parallel with contacts 6 and does not provide structural support for contacts 6. Contacts 6 are supported by the housing of outlet 8. The modular element 100 may similarly be supported by the housing of outlet 8 and be removably mounted to the housing. For example, the modular element may fit within a recess of housing of outlet 8 and secured with a removable panel.

Modular element 100 includes a number of leads 102 that make electrical contact with contacts 6 through a physical connection. Preferably, the modular element 100 is not soldered or otherwise securely fastened to the contacts 6 so that the modular element may be easily removed and replaced. As described in further detail herein, the modular element 100 may provide a number of functions such as compensating for crosstalk across connectors, etc. This allows the characteristics of the outlet 8 to be easily modified. The modular element 100 may include reactive elements (inductance, capacitance) to compensate for crosstalk across the contacts 6.

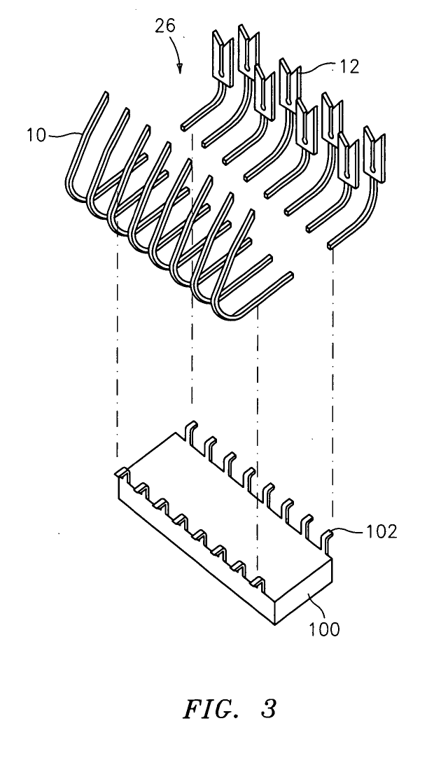

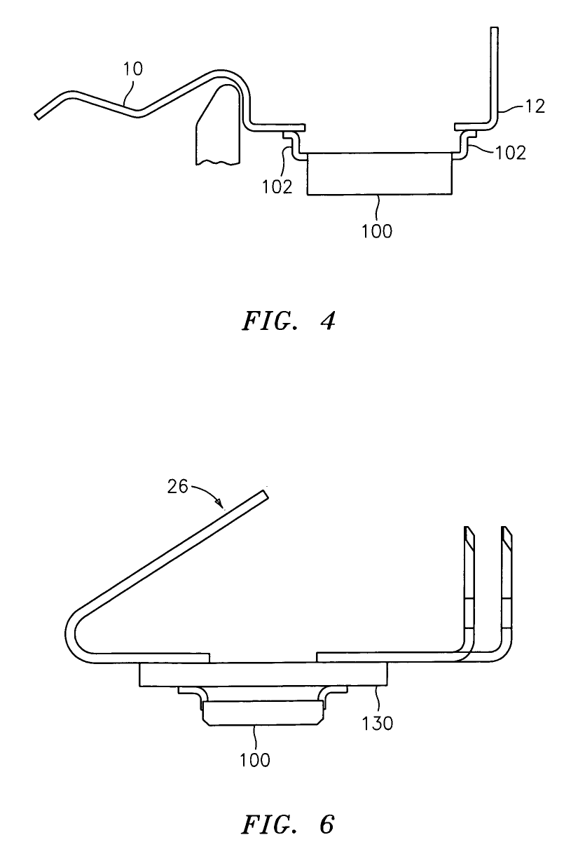

FIG. 3 depicts contacts 26 in an alternate embodiment of the invention. In FIG. 3, the contacts 26 have a discontinuous electrical path, such that the modular element 100 is placed in electrical series with the first end 10 and second end 12 of the contacts. FIG. 4 shows an exemplary arrangement of contacts 26 and the modular element 100. The first end 10 and second end 12 of the contacts 26 are supported by the housing of the outlet 8. This allows the modular element 100 to be removed and replaced without disturbing the mechanical integrity of the contacts. The contact portion 10 is similar to the contact described in U.S. Pat. No. 6,869,318 B2.

The modular element 100 may be used to tune the connector to certain performance characteristics. The modular element may include, for example, reactive elements (e.g., capacitances and inductances) that tune the frequency response to the connector so that certain performance levels can be achieved. One modular element 100 may tune the connector for category 5 performance and a more sophisticated modular element may tune the contactor for category 6 performance or beyond category 6. Thus, a standard set of contacts may be used and alternate modular elements 100 employed to achieve the desired level of performance.

The modular element 100 may also implement switching functions, either alone or in combination with frequency tuning. Switching functions include the ability for the outlet to provide alternate electrical paths as determined by the absence or presence of a plug, or through control by external software. For example, the switching function may direct a signal from a first contact to a second contact. An application of this may be in intelligent patching systems where an outlet's contacts may be selectively enabled.

Modular element 100 may be an integrated circuit (IC) chip or a printed circuit board. For high-frequency data transmission, electrical compensation elements (such as capacitances and inductances) may be distributed to the contacts used in the plug mating interface, to the contacts used for cable termination, and to the modular element 100.

The modular element 100 may be connected to the contacts in series, in parallel, or in a combination of both. The contacts may be manufactured using a number of methods, including stamping or wire-forming. The contacts may be held by various methods, including insert molding or by insertion into a contact holder. The plug-mating ends 10 and cable-terminating ends 12 of the contacts may both reside in one subassembly or in separate subassemblies. The outlet shown in FIG. 1 may have other configurations, such as one having the IDC contact portions being perpendicular to the plug receptacle plane.

The modular element 100 may be an integrated circuit (IC) implementing logic for controlling functions of the connector. The IC may include a microprocessor executing code to perform certain functions, an ASIC, Boolean logic, etc. In exemplary embodiments, the modular element 100 monitors signal transmission characteristics such as SNR, bit-error rate, etc. and controls switching of transmission paths and/or adjustments of compensation based on the monitored performance.

In exemplary embodiments, the modular element 100 includes an RIFD tag. The RIFD tag in the outlet may be used to identify the outlet and for security purposes. For example, the outlet may be deactivated (i.e., in a non-conductive state) until activated by a RFID reader, also referred to as an interrogator.

Utilizing a modular element 100 separate from the mechanical constructs of the connector provides a number of advantages. Embodiments of the invention provide greater manufacturing consistency, higher electrical performance and potential cost savings versus conventional PCBs and lead frame contacts. The modular element allows for greater degrees of freedom in the electrical compensation design. By delegating the electrical compensation function to the modular tuning element, the mechanical design of the outlet can be optimized for manufacturing ease and mechanical reliability. The electrical function of the outlet can be configured later in the manufacturing process by the addition of the tuning element 100. It is well known that greater manufacturing efficiencies can be achieved by delaying product configuration until late in the process. An example is the production of computer printers, where one chassis can be configured into multiple models. Additionally, the functions of the outlet can be configured or re-configured on-site by the installer or customer by replacing the modular element 100 with a new modular element.

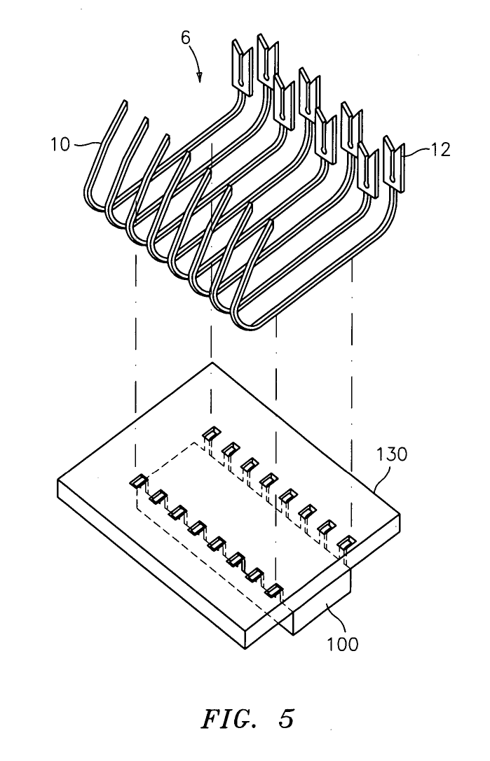

The modular element 100 may also be mounted on a printed circuit board. As shown in FIG. 5, modular element 100 is mounted on a PCB 130. The PCB 130 includes contact pads for making electrical contact with contacts 6 as described above with reference to FIGS. 2 and 3. Thus, the PCB 130 may be placed in series or in parallel with contacts 6. FIG. 6 depicts a modular element 100 mounted to a printed circuit board 130 in alternate embodiments. In FIG. 6, the PCB 130 and modular element 100 are in electrical series with contacts 26.

Embodiments of the invention are not limited to use with outlets. The modular element 100 may be used in a variety of telecommunications connector including plugs, outlets, patch panels, connecting block, etc.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A telecommunications connector comprising:
a housing;
a plurality of contacts mounted in the housing, the contacts having a first connection end and a second connection end;
a modular element having a plurality of leads in electrical contact with the plurality of contacts, the modular element removably mounted to the housing.

2. The telecommunications connector of claim 1 wherein the modular element is electrically in parallel with the contacts.

3. The telecommunications connector of claim 1 wherein the modular element is electrically in series with the contacts.

4. The telecommunications connector of claim 1 wherein the modular element includes reactive elements to compensate for crosstalk in the telecommunications connector.

5. The telecommunications connector of claim 5 wherein the reactive elements include at least one of inductance and capacitance.

6. The telecommunications connector of claim 1 wherein the modular element enables the telecommunication connector to achieve category 6 performance.

7. The telecommunications connector of claim 1 wherein the modular element implements a switching function to direct a signal from a first contact to a second contact.

8. The telecommunications connector of claim 1 wherein the first connection end of the contacts is an insulation displacement contact.

9. The telecommunications connector of claim 1 wherein the modular element is mounted on a printed circuit board, the printed circuit board having contact pads in electrical connection with the contacts.

10. The telecommunications connector of claim 1 wherein the modular element monitors signal transmission characteristics along the contacts and switches signal transmission along the contacts based on the signal transmission characteristics.

11. The telecommunications connector of claim 10 wherein the signal transmission characteristics include at least one of SNR and bit-error rate.

12. The telecommunications connector of claim 1 wherein the modular element includes an RIFD tag.

13. The telecommunications connector of claim 12 wherein the RIFD tag identifies the telecommunications connector.

14. The telecommunications connector of claim 12 wherein the modular element deactivates the telecommunications connector until activated by a RFID interrogator.

15. The telecommunications connector of claim 1 wherein the telecommunications connector is an outlet.

16. The telecommunications connector of claim 1 wherein the telecommunications connector is a plug.
